(19) United States
(12) Patent Application Publication
(10) Pub. No.: US 2004/0013491 A1
(43) Pub. Date: Jan. 22, 2004

(54) Anchor and nut assembly

(76) Inventor: Mun Yong Park, Siheung-City (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/276,456

(22) PCT Filed: May 18, 2001
(86) PCT No.: PCT/KR01/00826

(30) Foreign Application Priority Data
May 18, 2000 (KR) 2000/26717

(51) Int. Cl. F16B 13/06

(52) U.S. Cl. 411/44

(57) ABSTRACT

An anchor assembly includes an anchor bolt equipped with an anchor socket pressed into a concrete hole and screwed into the coil spring from an opening at one end of the anchor socket, thereby facilitating the anchor assembly's operation. The anchor socket includes a coil spring for fixing and fastening the anchor bolt. The anchor socket is provided with a slope portion having an inner wall, the diameter of which is gradually contracted toward the end portion thereof. The end portion has a plurality of slits formed through the socket in the longitudinal direction.

### BACKGROUND OF THE INVENTION

1. Technical Field

The present invention relates to an anchor and nut assembly used in an anchoring technique field, and more particularly, to an anchor and nut assembly capable of being fixed or fastened in a simple method.

2. Background Art

In fixing an anchor and fastening the anchor with an anchor bolt, Korean patent publication no. 1999-029991 discloses an anchor assembly for fixing an anchor in a hole of a wall body or a ceiling and fastening the anchor bolt with the anchor. The prior art is provided with a bush for passing an expansion member widened radially on an axis at an extended end portion, in which an opening is formed to insert the anchor into the hole of the wall body or the ceiling, and a screw thread formed on the anchor for coupling the anchor with the anchor bolt. The prior art must couple the anchor and the anchor bolt to each other by rotating the anchor bolt into the screw thread, since having the bush for maintaining the expansion member in the anchor socket and the screw thread formed on the anchor socket for coupling the anchor and the anchor bolt. Thus, the prior art has problem that an assembly period of time for coupling the anchor bolt into the anchor socket is too long.

### DISCLOSURE OF INVENTION

Therefore, Accordingly, the present invention is directed to an anchor and nut assembly that substantially obviates one or more problems due to limitations and disadvantages of the related art.

It is an object of the present invention to provide an anchor assembly capable of reducing an assembly period of time by simply coupling an anchor bolt into an anchor, preventing an expansion member from escaping from the anchor, and firmly fixing the anchor into a hole formed in a wall body.

It is another object of the present invention to provide a nut assembly using a simple coupling method to the anchor bolt in the anchor assembly.

1. To achieve the above objects, the present invention provides the anchor assembly, which has an expansion member, and an anchor socket having an inlet end portion formed at an end for inserting an anchor bolt and a cut portion formed at the other end axially, for fixing and fastening the anchor bolt, the anchor assembly including: a spring for fixing and supporting the anchor bolt, wherein the anchor socket includes: a slop portion supporting an end of the spring inside an inlet side for inserting the anchor bolt and having a sectional area gradually increased toward the other end portion of the anchor socket; an extended end portion radially expanded or contracted toward the end portion for supporting the expansion member at the end portion, the extended end portion having a cut portion in a longitudinal direction; an inner wall formed from the slop portion toward the extended end portion for locating the spring and the expansion member; and a neck portion formed between the inner wall and the extended end portion, wherein a contact surface of the spring contacted with the slop portion is reduced in an inner sectional area when the external force is applied to the spring toward the inlet end portion, and the extended end portion is radially widened when the expansion member is moved toward the extended end portion by the external force.

The anchor assembly according to the present invention includes the anchor socket, the spring and the expansion member. The anchor socket includes an inlet portion for inserting the anchor bolt at an end thereof and supporting the spring, a central portion having an inner wall for receiving the spring and the expansion member, and a fixing portion formed at the other end of the anchor socket for fixing and fastening the anchor assembly into a hole of a wall body and preventing the escape of the expansion member. The inlet portion is provided with an inlet for inserting the anchor bolt and a slop portion formed inside in such a manner that a sectional area of the slop portion is gradually increased toward the center of the anchor socket near the inlet. The spring is inserted into the inlet side of the inner wall of the central portion and the expansion member is located on the fixing portion side. The fixing portion is provided with a neck portion at an end of the inner wall, and an extended end portion radially expanded and contracted from the neck portion toward the end portion and having a cut portion. The extended end portion has the thickness gradually increased from the neck portion toward the end portion.

The present invention can be changed, converted, replaced and substituted within a range of the business model, technical method and system and is not restricted in the above.

### BRIEF DESCRIPTIONS OF THE DRAWINGS

Further objects and advantages of the invention can be more fully understood from the following detailed description taken in conjunction with the accompanying drawing in which:

FIG. 1 illustrates a perspective view, in partial section, of an anchor assembly according to the present invention;

FIG. 2 illustrates a perspective view of each component of the anchor assembly according to the present invention;

FIG. 3 illustrates a partially sectional view showing a state that an anchor bolt is coupled into the anchor assembly according to the present invention;

FIG. 4 illustrates a perspective view, in partial section, of a nut assembly according to the present invention; and

FIG. 5 illustrates a perspective, in partial section, of nut assembly according to other embodiment of the present invention.

### BEST MODE FOR CARRYING OUT THE INVENTION

An anchor assembly according to the present invention is assembled and used in the following order.

An anchor socket is manufactured in a state that a cut portion is formed. In the manufactured anchor socket, a spring is inserted from an extended end portion toward a slop portion, and then an expansion member is inserted. After that, the extended end portion is expanded and contracted for preventing the spring and the expansion member from escaping from the anchor socket.

The extended end portion of the assembled anchor assembly is inserted into a hole formed in a wall body. When the external force is applied to the expansion member by a hammer or other tools and move toward the extended end portion, the extended end portion is radially widened on a vertical axis through the expansion member. Then, the anchor assembly is fastened into the hole of the by the extended end portion and the expansion member.

After that, when being inserted into the inlet portion of the anchor assembly, the anchor bolt is inserted into the spring in contact with the spring, and the spring is located between a screw thread and a thread groove of the anchor bolt. After that, when the anchor bolt is moved toward the inlet portion again, the spring is contacted with the slop portion. When the spring is reduced in the contact area and contacted with the thread groove of the anchor bolt, the spring fixes and fastens the anchor bolt, like a female screw of a general nut. It is preferable that the spring is a coil spring. When the spring supports and compresses the expansion member, the expansion member is prevented from the escape through the inlet portion or the fixing portion and maintained in a fixed position by the spring even in a state that the anchor assembly is fastened on the wall body, and thereby the anchor assembly in itself can be more firmly fastened.

The present invention will now be described in detail in connection with preferred embodiments with reference to the accompanying drawings. For reference, like reference characters designate corresponding parts throughout several views.

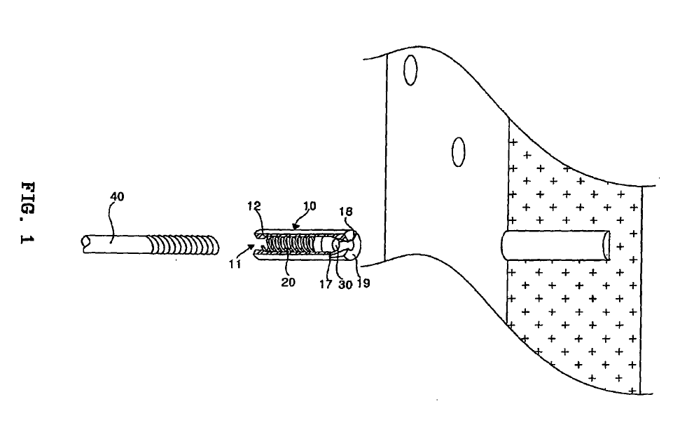

FIG. 1 illustrates a perspective view, in partial section, of an anchor assembly according to the present invention, and shows a state that components of the anchor assembly are assembled one another.

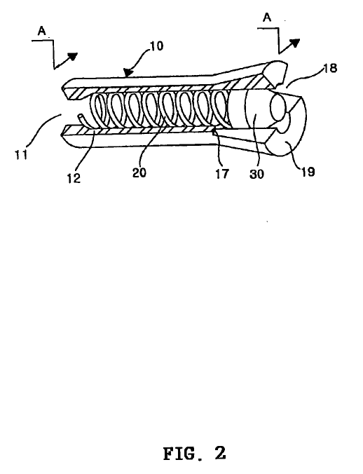

FIG. 2 illustrates a perspective view of each component of the anchor assembly according to the present invention, and shows a state before the components of the anchor assembly are assembled one another.

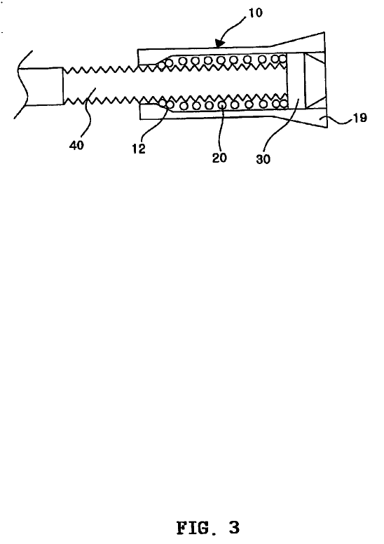

FIG. 3 illustrates a partially sectional view showing a state that an anchor bolt is coupled into the anchor assembly according to the present invention, and shows how the anchor bolt is fixed and fastened by the spring and the slop portion.

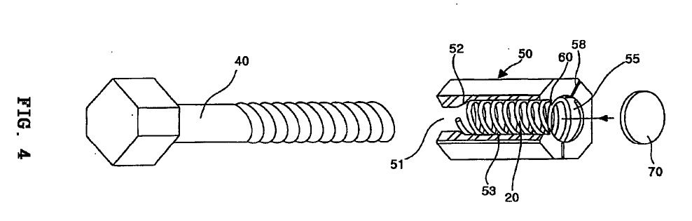

FIG. 4 illustrates a perspective view, in partial section, of one embodiment of nut assembly according to the present invention.

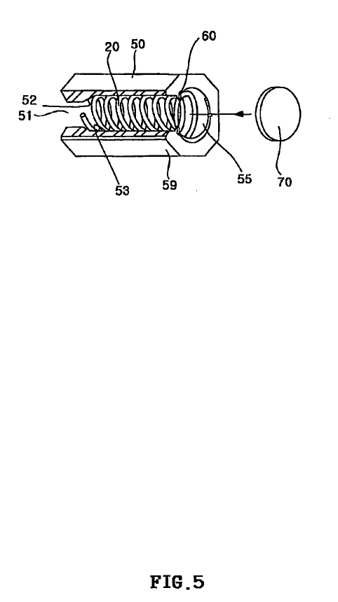

FIG. 5 illustrates a perspective, in partial section, of nut assembly according to other embodiment of the present invention.

FIGS. 1 and 2 illustrates a first preferred embodiment according to the present invention. In FIG. 1, the anchor socket 10 is provided with the inlet end portion 11 formed at an end thereof for inserting the anchor bolt or a member 40, which has a male screw thread, into the inlet end portion 11, and the slop portion 12 formed in a conic shape near the inlet end portion 11, the diameter of the slop portion being gradually contracted toward the other end portion of the anchor socket. The slop portion 12 includes the inner wall 13, the diameter of which is gradually contracted from the inlet end portion 11 toward the end portion thereof, and a neck portion 17 formed on the end portion of the inner wall 13. The anchor socket 10 further includes the extended end portion 19 capable of being expanded or contracted radially at the neck portion 17 toward the end portion, and at least one or more cut portions 18 formed axially toward the extended end portion 19. As shown in FIG. 1, the extended end portion 19 is axially increased in thickness, and thereby, in an assembled state of the anchor assembly, the neck portion 17 is smaller in cross sectional area than the end portion of the extended end portion 19.

The coil spring 20 is inserted into the inner wall 13 of the anchor socket 10. The coil spring 20 has an outer diameter larger than the inlet end portion 11, and an inner diameter equal to or smaller than the inlet end portion 11, larger than a core diameter of the anchor bolt and smaller than an outer diameter of the anchor bolt.

The expansion member 30 has an inlet axial diameter larger than the inner diameter of the coil spring 20 and an extended end diameter, which is a cut conic shape, smaller than the inlet axial diameter. The expansion member 30 is inserted between the coil spring 20 and the extended end portion 19 of the anchor socket 10, thereby being prevented from the escape by the extended end portion 19.

In FIG. 2, the anchor socket 10 is in a state before the coil spring 20 and the expansion member 30 are inserted, and the extended end portion 19 is widened radially on a vertical axis to insert the coil spring 20 and the expansion member 30.

As shown in FIG. 2, each component of the anchor assembly is manufactured, and first, the coil spring 20 is inserted through the extended end portion 19 of the anchor socket 10, and then, the expansion member 30 is inserted. Finally, when the extended end portion 19 is radially contracted in a central axis direction by the external force, the anchor assembly is completely assembled.

In the first embodiment, when the extended end portion 19 is inserted into the hole of the wall body and the expansion member 30 is moved longitudinally toward the extended end portion due to the external force by a hammer or a pin, the extended end portion 19 is radially expanded on to the vertical axis by the expansion member 30. Then, the anchor assembly is fastened in the hole of the wall body by the extended end portion 19.

After that, the anchor bolt is inserted in contact with the inside of the coil spring 20 when being inserted into the inlet end portion 11 of the anchor assembly, and then, contacted with a side of the expansion member. The coil spring 20 is located between the screw thread and a thread groove of the anchor bolt. At this time, referring to FIG. 3, when the anchor bolt is rotated once or twice in a right direction in case of a right-hand screw or in a left direction in case of a left-hand screw, the coil spring 20 is located approximately on the screw thread of the anchor bolt. After that, when the anchor bolt is moved toward the inlet end portion 11 again, the coil spring 20 is moved toward the slop portion 12 together with the anchor bolt. Then, the inner diameter of the coil spring 20 contacted with the slop portion 12 is contracted, and the coil spring 20 is more compressed to the thread groove of the anchor bolt, thereby being coupled with the anchor bolt. At this time, an end portion of the coil spring 20 located on the inlet end portion 11 of the anchor socket 10 is located between the screw portion of the anchor bolt and a slop surface of the slop portion 12, thereby preventing the escape of the anchor bolt. Thereby, the anchor bolt is coupled to the anchor assembly through the coil spring 20 like a known method that a general nut is coupled with the anchor bolt.

Referring to FIG. 4, a second preferred embodiment according to the present invention will be described in detail.

The nut assembly has a structure similar to the anchor assembly of FIG. 1. That is, the nut assembly has the same structure as the anchor assembly structure except the expansion member. However, to be used as a nut, a nut body 50 can be adjusted in length according to a user's use purpose and can be adjusted according to the length of a spring since an inner wall 53 of the nut body 50 receives only the spring in different from the inner wall of the anchor assembly. That is, an inlet portion, a central portion and a fixing portion of the anchor socket 10 are used as they are. In the nut assembly, the extended end portion 19 of the anchor assembly is not expanded during using since the nut assembly does not use the expansion member 30. Therefore, the fixing portion serves as a locking portion in the nut assembly. However, the locking portion is not manufactured in the same structure as the extended portion of the anchor assembly. As the locking portion is to prevent the escape of the spring, well-known appropriate means such as a ring can be used for the nut assembly. Alternatively, a projection or a calking process may be applied on the locking portion without using any member and the spring is inserted into the nut body by rotating the spring like a male screw, thereby preventing the escape of the spring by the expansion force.

The nut assembly according to the present invention includes the spring 20 for fixing and fastening the anchor bolt and the nut body 50. The nut body 50 is provided with an inlet end portion 51, a slop portion 52, the slop angle of which is made at the inlet end portion 51 in such a manner that a sectional area is gradually increased toward the end portion of the nut body 50 near the inlet end portion 51, an inner wall 53 formed toward the end portion of the axis from the slop portion 52, a neck portion 57 formed toward the end portion of the inner wall 53, an extended end portion 59 radially expanded or contracted from the neck portion 57 toward the end portion, and at least one or more cut portions 58 formed axially toward the extended end portion 59.

Referring to FIG. 5, in the nut assembly, the spring is inserted into the inner wall 53 of the nut body and is prevented from the escape by the locking portion 60. When the external force is applied to the spring 20 in a direction that the sectional area of the slop portion 52 is small, a contact surface of the spring 20 contacted with the slop portion 52 is reduced in an inner sectional area. The locking portion has a structure similar to the fixing portion of the anchor socket of the anchor assembly. Alternatively, the locking portion 60 may have a calking processed portion or a projection, but have the same function as the fixing portion.

Furthermore, it will be appreciated that the anchor bolt and a supporting portion of the spring are provided like the anchor assembly, a closing member 70 may be inserted into the nut body for closing an end of the nut body, and then the locking portion 60 is formed by the calking process.

### INDUSTRIAL APPLICABILITY

As described above, the effects of the anchor and nut assembly according to the present invention are as follows.

First, the anchor assembly according to the present invention can be easily and firmly fixed and fastened in the hole of the wall body. Additionally, the assembly period of time and process for fastening and coupling the anchor bolt with the anchor assembly are considerably reduced.

Second, the nut assembly according to the present invention can allow the anchor bolt to be simply coupled with the nut assembly.

Meanwhile, the sectional outer shape of the anchor socket and the nut body may be formed in a polygon for effectively transferring or supporting the coupling force by a clamping tool.

Therefore, the improved anchor and nut assembly is very simple, effective in achieving the above objects, safe, inexpensive and efficient, thereby overcoming the problems of the prior arts and providing new effects in this field.

If the features, discoveries and principles of the present invention are described, manners that a monitoring device and patch means are constructed and used and features and advantages of the components may be obtained.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention. The new effective structure, device, element, arrangement, component, combination and method are described in claims.

What is claimed is:

1. An anchor assembly, which has an expansion member, and an anchor socket having an inlet end portion formed at an end for inserting an anchor bolt and a cut portion formed at the other end axially, for fixing and fastening the anchor bolt, the anchor assembly comprising:
a spring for fixing and supporting the anchor bolt,
wherein the anchor socket includes: a slop portion supporting an end of the spring inside an inlet side for inserting the anchor bolt and having a sectional area gradually increased toward the other end portion of the anchor socket;
an extended end portion radially expanded or contracted toward the end portion for supporting the expansion member at the end portion, the extended end portion having a cut portion in a longitudinal direction;
an inner wall formed from the slop portion toward the extended end portion for locating the spring and the expansion member; and
a neck portion formed between the inner wall and the extended end portion,
wherein a contact surface of the spring contacted with the slop portion is reduced in an inner sectional area when the external force is applied to the spring toward the inlet end portion, and the extended end portion is radially widened when the expansion member is moved toward the extended end portion by the external force.

2. The anchor assembly according to claim 1, wherein the spring has an outer diameter larger than the inlet end portion, an inner diameter equal to or smaller than the inlet end portion, larger than a core diameter of the anchor bolt and smaller than an outer diameter of the anchor bolt.

3. A nut assembly having an inlet end portion in which an anchor bolt is inserted, the nut assembly comprising:
a spring for fixing and fastening the anchor bolt; and
a nut body having a slop portion having a slop angle in such a manner that a sectional area of the slop portion is gradually increased from the inlet end portion toward the other end portion, an inner wall formed from the slop portion toward the end portion thereof, and a locking portion formed toward the end portion of the inner wall,
wherein the spring is inserted into the inner wall of the nut body and prevented from the escape by the locking portion, and a contact surface of the spring contacted with the slop portion is reduced in an inner sectional area when the external force is applied to the spring toward the small sectional area of the slop portion.

4. The nut assembly according to claim 3, wherein the locking portion is provided with an outlet end portion at an end portion thereof for passing the anchor bolt or a member having a screw thread.

5. The nut assembly according to claim 3 or 4, wherein the locking portion includes a neck portion formed toward the end portion of the inner wall, an extended end portion radially expanded or contracted from the neck portion toward the end portion of the inner wall, and at least one or more cut portions formed axially toward the extended end portion.

6. The nut assembly according to claim 3 or 4, wherein the locking portion includes a projection through which the spring passes by the rotation.

7. The nut assembly according to claim 6, wherein the projection is made by a calking process.

8. The nut assembly according to one of claims 3 through 7, wherein the spring has an outer diameter larger than the inlet end portion, an inner diameter equal to or smaller than the inlet end portion, larger than a core diameter of the anchor bolt and smaller than an outer diameter of the anchor bolt.

9. An anchor assembly for preventing the release when an anchor bolt is coupled with the anchor assembly, the anchor assembly comprising:
a cylindrical anchor socket having an insertion hole formed in a longitudinal direction;
a spring inserted into the insertion hole in the longitudinal direction;
a conic expansion member elastically supported at a portion of the spring against a wall body;
an extended portion having a plurality of cut portions formed at a portion of the insertion hole against the wall body in a longitudinal direction, the extended portion being fit into a hole of a wall body, and at the same time, closely fixed to the hole of the wall body while expanded according to the axial movement of the expansion member toward the wall body by the external force; and
a slop portion formed in the inside of the end portion of the extended portion of the anchor socket,
wherein a support part is a side of the expansion member axially moved, and the other support part is the slop portion reducing the inner diameter of the spring for serving as a female screw forcedly coupling a male screw of the anchor bolt by inserting and rotating the anchor bolt.

10. The anchor assembly according to claim 9, wherein the spring has an elastic force in an opposite direction to the direction that the anchor bolt is inserted.

11. The anchor assembly according to claim 9, wherein the anchor socket is in the form of a polygon in an outer sectional shape.

12. The anchor assembly according to claim 9, wherein the expanded end portion has a vertical sectional shape, the sectional area of which is gradually increased toward the end portion of the opening of the wall body.

13. The anchor assembly according to claim 9, wherein the anchor bolt is fixed and fastened to the anchor socket by being rotated once or twice.

14. A method for assembling the anchor assembly of claim 1, comprising the steps of inserting the spring and the expansion member into the anchor socket, and tightening the extended portion with a jig or a tightening tool in such a manner that a size of the hole of the wall body becomes smaller than a prescribed size.

15. A nut assembly for preventing the release when an anchor bolt is coupled with the nut assembly, the nut assembly comprising:
a cylindrical nut body having an insertion hole formed in a longitudinal direction;
a spring inserted into the insertion hole in the longitudinal direction;
a locking portion disposed at an end portion of the anchor socket for elastically mounting an end of the spring and fastening a closing member for closing an end of an insertion hole of the nut body; and
a slop portion formed in the inside of the other end portion of the locking portion of the anchor socket for reducing an inner diameter of the spring for serving as a female screw forcedly coupling a male screw of the anchor bolt by inserting and rotating the anchor bolt.

16. The nut assembly according to claim 15, wherein the locking portion made by a calking process.

17. The nut assembly according to claim 15, wherein the nut body is in the form of a polygon in an outer sectional shape.

18. The nut assembly according to claim 15, wherein the spring has an elastic force in an opposite direction to the direction that the anchor bolt is inserted.

19. The nut assembly according to claim 4, wherein the anchor bolt is fixed and fastened to the anchor socket by being rotated once or twice.
